(19) United States
(12) Patent Application Publication
(10) Pub. No.: US 2015/0242802 A1
(43) Pub. Date: Aug. 27, 2015

(54) DISTRIBUTED LEARNING SYSTEM AND METHOD FOR PRESENTING A SALES PITCH

(71) Applicant: BSHARP SALES ENABLERS PRIVATE LIMITED, Bangalore (IN)

(72) Inventors: PRITHVIRAJ BANERJEE, CHELMSFORD, MA (US); GOPAL SWAMINATHAN, BANGALORE (IN)

(21) Appl. No.: 14/625,706

(22) Filed: Feb. 19, 2015

(30) Foreign Application Priority Data
Feb. 24, 2014 (IN) 901/CHE/2014

(51) Int. Cl. G06Q 10/06

(52) U.S. Cl. CPC G06Q 10/063118; G06Q 10/06398

(57) ABSTRACT

The embodiments herein provide a method and system for presenting a sales pitch. The method comprises receiving information about a client from a plurality of sources, creating a client profile based on the received information about the client, training one or more sales personnel based on the client profile, generating one or more demonstrations of a sales pitch, wherein the one or more sales pitch is demonstrated by the sales personnel, posting the one or more generated demonstrations of the sales pitch to a server, verifying the one or more similar presentations having a favorable outcome and presenting the one or more posted presentations of the sales pitch by the sales personnel to the client, wherein the presentations are recorded in real-time, geo-stamped, and time-stamped.

### CROSS REFERENCE TO RELATED APPLICATIONS

This patent application claims the priority of the Indian Provisional Patent Application No. 901/CHE/2014 filed on Feb. 24, 2014, having the title “Distributed Learning System and Method for Training Field Sales Force”, and the content of which is incorporated herein by reference in its entirely.

### BACKGROUND

1. Technical Field

The embodiments herein are generally related to training and marketing systems. The embodiments herein are particularly related to a system and method for presenting a sales pitch. The embodiments herein are more particularly related to a computerized distributed learning technique for training sales personnel and presenting a sales pitch for targeted products, services, and offerings

2. Description of the Related Art

Sales training is an effort puts forth by an employer to provide sales personnel with job-related culture, skills, knowledge, and attitudes for improving a sales performance in the selling environments. Basically, sales training is designed to change or reinforce behavior that makes the sales personnel to achieve their job goals more efficiently. The companies are interested in training the sales personnel primarily to increase sales, productivity and profits. The companies appoint sales managers as trainers of their sales personnel. It is important for the sales managers to be familiar with planning, organizing, staffing, directing, and evaluating a training program.

The goal of building a successful sales culture in the changing global environment places new demands on training departments and requires organizations to develop innovative and comprehensive approaches that extend beyond geographic and time limitations. Real-time training, one-to-one coaching, and behavioral-change training are just some of the strategies applied by the companies to the sales training curricula across the country.

The existing approach for training the sales personnel consists of steps, in which an upfront training session(s) (which can be a face to face or a distributed learning) are conducted initially, followed by an assessment(s) before the sales campaign starts. The effectiveness of the training is assessed based on a performance of a sale force during a campaign. Hence the performance of a sales personnel is only determined after the completion of the sales campaign. A drawback seen in the existing approach is a lack of visibility of a transformation of the impaired knowledge to a sales personnel during the campaign. Another drawback of the existing system is found in the level of involvement of sales personnel. The results of training become unpredictable when an individual has all the relevant knowledge but has not effectively involved oneself towards the goals of the campaign.

Further, the conventional training method have to deal with the problem of making a sales person effective from the perspective of selling to a customer is via systems like Product Lifecycle Management (PLM), Customer Relationship Management (CRM), learning management, web content management, and the like. This conventional methods solve the problem in a single vertical at a great depth. However, the conventional methods fail to make an impact when they have to make interaction with the customer more effectively.

Hence there is a need for a method and system for providing the right functionality for training and detailing the sales pitch to the sales personnel for one or more products and services. There is a further need for a system and method for leveraging mobile and cloud technologies to present sales pitch more effectively. There is still further need for customization of the platform to make one or more features relevant and attractive.

The above mentioned shortcomings, disadvantages and problems are addressed herein and which will be understood by reading and studying the following specification.

### OBJECTS OF THE EMBODIMENTS HEREIN

The primary objective of the embodiments herein is to provide a method and system for presenting a sales pitch.

Another objective of the embodiments herein is to provide an improved method and system for providing a distributed learning technique for training the sales personnel.

Yet another objective of the embodiments herein is to provide a real time feedback on a performance of sales personnel during the training and sales campaign.

Yet another objective of the embodiments herein is to asynchronously conduct quizzes linked to the training to measure responsiveness and campaign knowledge of the sales personnel.

Yet another objective of the embodiments herein is to provide a system that generates a readiness index which represents the extent of readiness of a given sales person with respect to a defined objective.

Yet another objective of the embodiments herein is to generate a field sharpness index for representing an extent of readiness of the sales personnel with respect to a defined objective.

Yet another objective of the embodiments herein is to track the sales personnel in real-time.

Yet another objective of the embodiments herein is to leverage the mobile and cloud computing technologies to make the solution more effective.

Yet another objective of the embodiments herein is to include gamification in the system to make features more relevant and attractive.

Yet another objective of the embodiments herein is to provide right functionality for training and detailing the sales pitch to the sales personnel for targeted products and offerings.

Yet another objective of the embodiments herein is to develop one or more features by working and receiving plurality of the sales personnel.

Yet another objective of the embodiments herein is to build a system for presenting the one or more sales pitch using the mobile technology.

Yet another objective of the embodiments herein is to develop a holistic approach for presenting the one or more sales pitch to the plurality of clients.

Yet another objective of the embodiments is to provide a plurality of the case studies to the plurality of the sales personnel for increasing the efficiency of the distributed learning and present the one or more sales pitch effectively.

These and other objects and advantages of the embodiments herein will become readily apparent from the following detailed description taken in conjunction with the accompanying drawings.

### SUMMARY

The embodiments herein provide a system and method for training a plurality of sales personnel using a distributed learning method for presenting an effective sales pitch. The method comprises receiving information about a client from a plurality of sources, creating a client profile using a profiling module, and training one or more sales personnel using an online and an offline mode based on the client profile using a training module. The step of creating a client profile includes receiving information about the client, and the client profile is created based on one or more parameters. The online mode of training refers to training the sales personnel using web-enabled applications, and the offline mode of training refers to a classroom training of the one or more sales personnel. The training of the one or more sales personnel is through a distributed learning technique.

According to one embodiment herein, the method further comprises generating one or more demonstrations of a sales pitch using a presentation module, posting the one or more generated demonstrations of the sales pitch to a server using the presentation module, verifying the one or more similar presentations that has got favorable outcome, and presenting the one or more posted presentations of the sales pitch on a computing device by the sales personnel to the client.

According to one embodiment herein, the one or more sales pitch is demonstrated by the sales personnel, and the presentations are recorded in real-time, geo-stamped, and time-stamped.

According to one embodiment herein, the computing device includes a computer, smart-phone, personal-digital assistant, projector having one or more applications such as email, secure mobile applications for providing access to the one or presentations to the client.

According to one embodiment herein, the step of obtaining the information about the client in a plurality of the sources includes collecting information directly from the client, and acquiring information about the client indirectly from a plurality of other sources.

According to one embodiment herein, the one or more parameters for creating the client profile is pre-set and the one or more pre-set parameters include information of the client, market position the client, client interest level, resources provided by the client and summary of the client. The one or more parameters are pre-set by authorized personnel. The one or more parameters for creating the client profile is set by a rule-engine.

According to one embodiment herein, the step of training the plurality of sales personnel using the training module through the distributed learning technique comprises conducting an initial training for the plurality of the sales personnel, conducting a quiz based on the initial training using a quiz module, initiating a sales campaign, conducting a plurality of quizzes using the quiz module over the period of sales campaign, generating a real-time feedback for each of the plurality of quizzes conducted, generating triggers using a trigger module when the performance of the sales personnel is low, conducting a booster training using a booster module based on the trigger generated, calculating a readiness index for each of the plurality of the sales personnel using the readiness-index module, and calculating a field sharpness index of the sales team comprising the plurality of sales personnel using the field sharpness index module by convolving the individual readiness indices of the constituent sales team personnel.

According to one embodiment herein, the step of conducting the initial training for the plurality of the sales personnel includes familiarizing the plurality of the sales personnel with a product knowledge, one or more sales techniques, and name gathering.

According to one embodiment herein, the quiz is conducted for measuring the performance and understanding levels of the plurality of sales personnel in the initial training.

According to one embodiment herein, the sales campaign is initiated by the sales manager and the plurality of the quizzes are conducted for measuring the performance of the sales personnel. The feedback for the plurality of the quizzes is generated based on one or more parameters and the one or more parameters for the quizzes are pre-determined parameters. The readiness index is calculated for measuring the readiness of the plurality of the sales personnel and the readiness index is calculated based on one or more parameters;

According to one embodiment herein, the step of generating one or more demonstrations of the sales pitch comprises creating a generic content, creating a specific content, providing a tool for customizing the generic content, and providing a tool for customizing the specific content. The generic content includes general introduction and specific content includes information about the product and service to be demonstrated to the client.

According to one embodiment herein the one or more demonstrations of the sales pitch generated are encrypted and secured using one or more secure protocol. The demonstration of the sales pitch includes the presentation of the product and service to the client through electronic and non-electronic medium.

According to one embodiment herein, the method further comprises call recording and matching using the call recording and matching module, wherein call recording and matching is carried out for providing the sales personnel with the similar sales pitch conducted earlier.

According to one embodiment herein, the method further comprises sharing the one or more presentations with the client on a client device which is a computing device using one or more ways, and wherein the one or more ways of sharing include a sharing process using a web application, a mobile application, and a vault application.

According to one embodiment herein, the one or more posted presentations have one or more fields to include feedback from the sales personnel, and the client.

The embodiments herein provide a system for presenting a sales pitch. The system comprises, a server configured for running a plurality of the applications received from plurality of sources, a client database for storing information about a plurality of the clients, a sales personnel database for storing information about a plurality of the sales personnel, a content module for storing a plurality of the information related to the service and product offerings, marketing and sales assets, a training module configured for providing a customized training according to the requirement of the client, a presentation module configured for creating and posting one or more sales pitch demonstration on a web server, a client device for demonstrating the one or more sales pitch, and a verification module configured for verifying activities of the pluralities of the sales personnel.

According to one embodiment herein, the training module comprises, a quiz module configured for providing a plurality of quizzes for the plurality of the sales personnel and receiving the answers from the plurality of the sales personnel, a trigger module configured for triggering an authorized personnel when performance is low, a booster module configured for providing booster training for one or more sales personnel, a readiness-index module configured for calculating a readiness-index of each of the plurality of the sales personnel, a field sharpness index module for calculating a field sharpness of the each of the plurality of the sales personnel and an access terminal for accessing a plurality of the contents.

According to one embodiment herein, the performance refers to the ability of the individual personnel to answer to the plurality of quizzes with respect to a defined objective.

According to one embodiment herein, the readiness-index refers to the extent of the readiness of the individual sales personnel with respect to a defined objective.

According to one embodiment herein, the field sharpness index refers to the extent of readiness of the plurality of the sales personnel with respect to a defined objective.

According to one embodiment herein, the access terminal is present on the computing device used for accessing the posted presentation. The plurality of the contents includes login registration details of the sales personnel, plurality of scores from quizzes, one or more contents to be demonstrated, and a feedback.

According to one embodiment herein, the system comprises a recording and matching module configured for recording a demonstration of the plurality of the presentations and matching the one or more demonstrations in the past based on one or more parameters. The one or more parameters include similar presentations, similar clients, and presentations referring to similar target audience.

According to one embodiment herein, the call recording and matching module comprises a call pattern matching module for matching the one or more similar presentations contextually.

According to one embodiment herein, the system comprises a rule engine for setting one or more parameters for a plurality of modules for presenting the sales pitch.

The various embodiments herein provide a computer implemented method for presenting a sales pitch or forum using computing device. The method comprises storing instructions on a non-transitory computer readable storage medium and executed on one or more processors to perform the steps of receiving information about a client from a plurality of sources, creating a client profile using a profiling module, creating a product and service profile using the profiling module, training one or more sales personnel using an online and an offline mode based on the client profile using a training module, posting the one or more generated demonstrations of the sales pitch to a server using the presentation module, and presenting the one or more posted presentations of the sales pitch on a computing device.

According to one embodiment herein, the computing device includes a computer, smart-phone, personal-digital assistant, and projector having one or more applications for giving access to the client for the one or more presentations. According to one embodiment herein, the one or more applications include email, secure companion mobile app, and wherein the presentations are recorded in real-time, geo-stamped, and time-stamped.

According to one embodiment herein, the step of obtaining the information about the client in a plurality of the sources includes collecting information directly from the client, and acquiring information about the client indirectly from a plurality of other sources.

According to one embodiment herein, the one or more parameters for creating the client profile is pre-set, wherein the one or more pre-set parameters include information of the client, market position the client, client interest level, resources provided by the client, and summary of the client, and wherein the one or more parameters are pre-set by authorized personnel.

According to one embodiment herein, the step of training the plurality of sales personnel using the training module through the distributed learning technique comprises, conducting an initial training for the plurality of the sales personnel, conducting a quiz based on the initial training using a quiz module, initiating a sales campaign, conducting a plurality of quizzes using the quiz module over the period of campaign, wherein the plurality of the quizzes are conducted for measuring the performance of the sales personnel, generating a real-time feedback for each of the plurality of quizzes conducted, generating triggers using a trigger module when the performance of the sales personnel is low, conducting a booster training using a booster module based on the trigger generated, calculating a readiness index for each of the plurality of the sales personnel using the readiness-index module, wherein the readiness index is calculated for measuring the readiness of the plurality of the sales personnel, and calculating a field sharpness index of the sales team comprising the plurality of sales personnel using the field sharpness index module by convolving the individual readiness indices of the constituent sales team personnel.

According to one embodiment herein, the step of generating one or more demonstrations of a sales pitch comprises creating a generic content, creating a specific content, and providing a tool for customizing the generic content, and the specific content, wherein the generic content includes general introduction, and specific content includes information about the product and service to be demonstrated to the client.

According to one embodiment herein, the computer implemented method further comprises encrypting and securing the one or more demonstrations of the sales pitch using one or more secure protocol. According to one embodiment herein, the demonstration of the sales pitch include the presentation of the product and service to the client through electronic and non-electronic medium.

According to one embodiment herein, the computer implemented method further comprises performing call recording and matching processes using the call recording and matching module, wherein call recording and matching is for providing the sales personnel with the similar sales pitch conducted earlier.

According to one embodiment herein, the computer implemented method further comprises sharing the one or more presentation with the client on a computing device using one or more ways, wherein the one or more ways include sharing using a web application, a mobile application, and a vault application.

According to one embodiment herein, the computer implemented method comprises providing the one or more posted presentation with one or more field to include feedback from the sales personnel, and the client.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flow chart explaining a method for presenting a sales pitch, according to one embodiment herein.

FIG. 2 illustrates a block diagram of a system for presenting a sales pitch, according to one embodiment herein.

FIG. 3 illustrates a block diagram of a distributed learning system for training sales personnel, according to one embodiment herein.

FIG. 4 illustrates is a schematic block diagram of a timeline representation of the initial training and campaign, according to one embodiment herein.

FIG. 5 illustrates is a schematic block diagram of a timeline representation for generating triggers to initiate corrective actions, according to one embodiment herein.

FIG. 6 illustrates is a schematic block diagram a timeline representation for booster trainings conducted during the sales campaign, according to one embodiment herein.

FIG. 7 illustrates is a schematic block diagram of a timeline representation for Readiness Index (RI) of an individual sales person, according to one embodiment herein.

FIG. 8 illustrates is a schematic block diagram of a timeline representation for Field Sharpness Index (FSI) of a sales team, according to one embodiment herein.

FIG. 9 illustrates a graphical user interface displaying a configurable login screen for the user to access the system, according to one embodiment herein.

FIG. 10 illustrates a graphical user interface displaying a configurable training screen for the user to edit training content, according to one embodiment herein.

FIG. 11 illustrates a graphical user interface displaying a screen for displaying aggregated reports on trainings, according to one embodiment herein.

FIG. 12 illustrates a graphical user interface indicating a display screen of a mobile application for accessing the system by the user, according to one embodiment herein.

FIG. 13 illustrates a flowchart explaining a distributed learning method for training the sales personnel according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE INVENTION

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein provide a system and method for training a plurality of sales personnel using a distributed learning method for presenting an effective sales pitch. The method comprises receiving information about a client from a plurality of sources, creating a client profile using a profiling module, and training one or more sales personnel using an online and an offline mode based on the client profile using a training module. The step of creating a client profile includes receiving information about the client, and the client profile is created based on one or more parameters. The online mode of training refers to training the sales personnel using web-enabled applications, and the offline mode of training refers to a classroom training of the one or more sales personnel. The training of the one or more sales personnel is through a distributed learning technique.

According to one embodiment herein, the method further comprises generating one or more demonstrations of a sales pitch using a presentation module, posting the one or more generated demonstrations of the sales pitch to a server using the presentation module, verifying the one or more presentations having the favorable outcomes, and presenting the one or more posted presentations of the sales pitch on a computing device by the sales personnel to the client.

According to one embodiment herein, the one or more sales pitch is demonstrated by the sales personnel, and the presentations are recorded in real-time, geo-stamped, and time-stamped.

According to one embodiment herein, the computing device includes a computer, smart-phone, personal-digital assistant, projector having one or more applications such as email, secure mobile sharing app, where the one or more required presentations is shared with the clients securely.

According to one embodiment herein, the step of obtaining the information about the client in a plurality of the sources includes collecting information directly from the client, and acquiring information about the client indirectly from a plurality of other sources.

According to one embodiment herein, the one or more parameters for creating the client profile is pre-set and the one or more pre-set parameters include information of the client, market position the client, client interest level, resources provided by the client and summary of the client. The one or more parameters are pre-set by authorized personnel. The one or more parameters for creating the client profile is set by a rule-engine.

According to one embodiment herein, the step of training the plurality of sales personnel using the training module through the distributed learning technique comprises conducting an initial training for the plurality of the sales personnel, conducting a quiz based on the initial training using a quiz module, initiating a sales campaign, conducting a plurality of quizzes using the quiz module over the period of sales campaign, generating a real-time feedback for each of the plurality of quizzes conducted, generating triggers using a trigger module when the performance of the sales personnel is low, conducting a booster training using a booster module based on the trigger generated, calculating a readiness index for each of the plurality of the sales personnel using the readiness-index module, and calculating a field sharpness index of the sales team comprising the plurality of sales personnel using the field sharpness index module by convolving the individual readiness indices of the constituent sales team personnel.

According to one embodiment herein, the step of conducting the initial training for the plurality of the sales personnel includes familiarizing the plurality of the sales personnel with a product knowledge, one or more sales techniques, and name gathering.

According to one embodiment herein, the quiz is conducted for measuring the performance and understanding levels of the plurality of sales personnel in the initial training.

According to one embodiment herein, the sales campaign is initiated by the sales manager and the plurality of the quizzes are conducted for measuring the performance of the sales personnel. The feedback for the plurality of the quizzes is generated based on one or more parameters and the one or more parameters for the quizzes are pre-determined parameters. The readiness index is calculated for measuring the readiness of the plurality of the sales personnel and the readiness index is calculated based on one or more parameters;

According to one embodiment herein, the step of generating one or more demonstrations of the sales pitch comprises creating a generic content, creating a specific content, providing a tool for customizing the generic content, and providing a tool for customizing the specific content. The generic content includes general introduction and specific content includes information about the product and service to be demonstrated to the client.

According to one embodiment herein, the one or more demonstrations of the sales pitch generated are encrypted and secured using one or more secure protocol. The demonstration of the sales pitch includes the presentation of the product and service to the client through electronic and non-electronic medium.

According to one embodiment herein, the method further comprises call recording and matching using the call recording and matching module, wherein call recording and matching is carried out for providing the sales personnel with the similar sales pitch conducted earlier.

According to one embodiment herein, the method further comprises sharing the one or more presentations with the client on a client device which is a computing device using one or more ways, and wherein the one or more ways of sharing include a sharing process using a web application, a mobile application, and a vault application.

According to one embodiment herein, the one or more posted presentations have one or more fields to include feedback from the sales personnel, and the client.

The embodiments herein provide a system for presenting a sales pitch. The system comprises, a server configured for running a plurality of the applications received from plurality of sources, a client database for storing information about a plurality of the clients, a sales personnel database for storing information about a plurality of the sales personnel, a content module for storing the plurality of information about the product and service offerings, marketing and sales assets, a training module configured for providing a customized training according to the requirement of the client, a presentation module configured for creating and posting one or more sales pitch demonstration on a web server, a client device for demonstrating the one or more sales pitch, and a verification module configured for verifying activities of the pluralities of the sales personnel.

According to one embodiment herein, the training module comprises, a quiz module configured for providing a plurality of quizzes for the plurality of the sales personnel and receiving the answers from the plurality of the sales personnel, a trigger module configured for triggering an authorized personnel when performance is low, a booster module configured for providing booster training for one or more sales personnel, a readiness-index module configured for calculating a readiness-index of each of the plurality of the sales personnel, a field sharpness index module for calculating a field sharpness of the each of the plurality of the sales personnel and an access terminal for accessing a plurality of the contents.

According to one embodiment herein, the performance refers to the ability of the individual personnel to answer to the plurality of quizzes with respect to a defined objective.

According to one embodiment herein, the readiness-index refers to the extent of the readiness of the individual sales personnel with respect to a defined objective.

According to one embodiment herein, the field sharpness index refers to the extent of readiness of the plurality of the sales personnel with respect to a defined objective.

According to one embodiment herein, the access terminal is present on the computing device used for accessing the posted presentation. The plurality of the contents includes login registration details of the sales personnel, plurality of scores from quizzes, one or more contents to be demonstrated, and a feedback.

According to one embodiment herein, the system comprises a recording and matching module configured for recording a demonstration of the plurality of the presentations and matching the one or more demonstrations in the past based on one or more parameters. The one or more parameters include similar presentations, similar clients, and presentations referring to similar target audience.

According to one embodiment herein, the call recording and matching module comprises a call pattern matching module for matching the one or more similar presentations contextually.

According to one embodiment herein, the system comprises a rule engine for setting one or more parameters for a plurality of modules for presenting the sales pitch.

The various embodiments herein provide a computer implemented method for presenting a sales pitch or forum using computing device. The method comprises storing instructions on a non-transitory computer readable storage medium and executed on one or more processors to perform the steps of receiving information about a client from a plurality of sources, creating a client profile using a profiling module, creating a product and service profile using the profiling module, training one or more sales personnel using an online and an offline mode based on the client profile using a training module, posting the one or more generated demonstrations of the sales pitch to a server using the presentation module, and presenting the one or more posted presentations of the sales pitch on a computing device.

According to one embodiment herein, the computing device includes a computer, smart-phone, personal-digital assistant, and projector having one or more applications for giving access to the client for the one or more presentations. According to one embodiment herein, the one or more applications include email, secure companion mobile app, and wherein the presentations are recorded in real-time, geo-stamped, and time-stamped.

According to one embodiment herein, the step of obtaining the information about the client in a plurality of the sources includes collecting information directly from the client, and acquiring information about the client indirectly from a plurality of other sources.

According to one embodiment herein, the one or more parameters for creating the client profile is pre-set, wherein the one or more pre-set parameters include information of the client, market position the client, client interest level, resources provided by the client, and summary of the client, and wherein the one or more parameters are pre-set by authorized personnel.

According to one embodiment herein, the step of training the plurality of sales personnel using the training module through the distributed learning technique comprises, conducting an initial training for the plurality of the sales personnel, conducting a quiz based on the initial training using a quiz module, initiating a sales campaign, conducting a plurality of quizzes using the quiz module over the period of campaign, wherein the plurality of the quizzes are conducted for measuring the performance of the sales personnel, generating a real-time feedback for each of the plurality of quizzes conducted, generating triggers using a trigger module when the performance of the sales personnel is low, conducting a booster training using a booster module based on the trigger generated, calculating a readiness index for each of the plurality of the sales personnel using the readiness-index module, wherein the readiness index is calculated for measuring the readiness of the plurality of the sales personnel, and calculating a field sharpness index of the sales team comprising the plurality of sales personnel using the field sharpness index module by convolving the individual readiness indices of the constituent sales team personnel.

According to one embodiment herein, the step of generating one or more demonstrations of a sales pitch comprises creating a generic content, creating a specific content, and providing a tool for customizing the generic content, and the specific content, wherein the generic content includes general introduction, and specific content includes information about the product and service to be demonstrated to the client.

According to one embodiment herein, the computer implemented method further comprises encrypting and securing the one or more demonstrations of the sales pitch using one or more secure protocol. According to one embodiment herein, the demonstration of the sales pitch include the presentation of the product and service to the client through electronic and non-electronic medium.

According to one embodiment herein, the computer implemented method further comprises performing call recording and matching processes using the call recording and matching module, wherein call recording and matching is for providing the sales personnel with the similar sales pitch conducted earlier.

According to one embodiment herein, the computer implemented method further comprises sharing the one or more presentation with the client on a computing device using one or more ways, wherein the one or more ways include sharing using a web application, a mobile application, and a vault application.

According to one embodiment herein, the computer implemented method comprises providing the one or more posted presentation with one or more field to include feedback from the sales personnel, and the client.

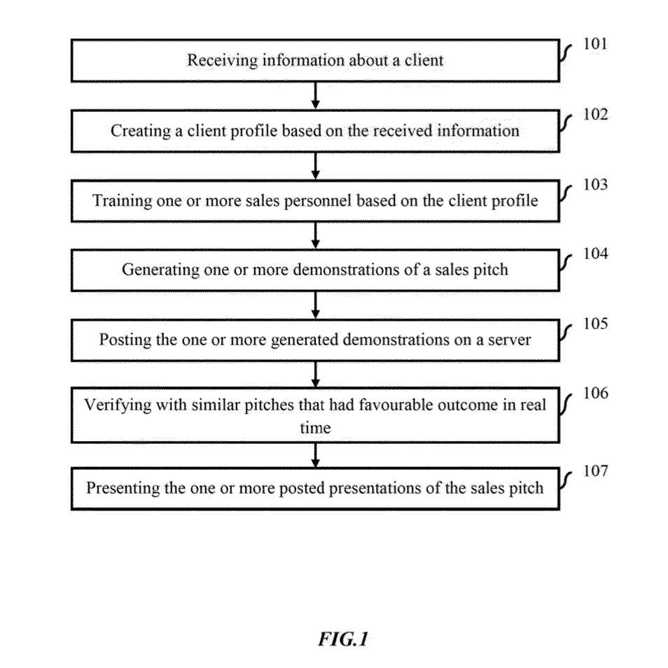

The various embodiments herein provide a method and system for presenting a sales pitch. FIG. 1 illustrates a flowchart explaining a method for presenting a sales pitch. The method comprises receiving information about a client from a plurality of sources (103). The received information about the client is stored in a client database. According to one embodiment herein, the information about the client is received both directly and indirectly.

According to one embodiment herein, information such as the product or service of interest for the client, budget of the client, an amount of non-monetary resources to be spent by the client on a product or service, resources to be implemented by the client for implementing the product and service in the market, and the like, are obtained directly from the client.

According to one embodiment herein, the indirect information about the client is obtained from a plurality of the sources. The indirect information about the client include but are not limited to the past products or services bought or sold by the client, financials of the client, market position of the client, stock market value of the client, importance of a particular product or service of the client, and the like. Further, the indirect information about the client is obtained from social media sites, client website, press-releases, market analysis, tracking the client and the like.

Once the information about the client is received, a client profile is created (Step 102). The client profile is created using a profiling module.

According to one embodiment herein, the profile module is configured automatically to create the client profile based on the inputs received.

According to one embodiment herein, the client profile is created manually using the tools provided by the profiling module.

According to one embodiment herein, the client profile is created based on one or more parameters. The one or more parameters for creating the client profile are pre-determined parameters.

According to one embodiment herein, the one or more parameters for creating the client profile is defined by the customer relationship manager, sales portfolio handlers, sales managers, sales executive officers, and the like.

According to one embodiment herein, the client profile is created manually by one or more concerned authorities such as sales managers, sales executive, and the like.

According to one embodiment herein, an intelligent system based on the one or more parameters received creates the client profile.

According to one embodiment herein, the client profile include basic information about the client, resources allocated by the client, importance of the client, type of product or service to be presented, list of one or more concerned personnel for whom the product or service is being presented, time allocated for the presentation, potential products or services the client is interested in, and the like.

One or more sales personnel is trained according to the client profile, based on distributed learning technique (Step 103). According to one embodiment herein, the training is provided to the one or more sales personnel using the training module. According to one embodiment herein, the training is provided using both online and offline modes. The online mode of training refers to training the sales personnel using web-enabled applications. For example, the online mode of the training include but are not limited to training provided using webinar, online training, and the like. The offline mode of training refers to training the sales personnel refers to classroom training. In the offline mode training, the sales training to the sales personnel is provided by authorized personnel such as sales trainer, senior sales executive, industry experts, and the like.

According to one embodiment herein, training the one or more sales personnel based on the distributed technique comprises conducting an initial training, conducting a quiz based on the initial training, initiating a sales campaign, conducting several quizzes over a period of the sales campaign, generating a real-time feedback of the each of the plurality of the sales personnel. Further, the distributed learning technique comprises generating triggers when the performance of the sales personnel is low, conducting a booster training based on the trigger generation, calculating a readiness index for each of the sales personnel, and calculating field sharpness index of the plurality of the sales personnel. According to one embodiment herein, the one or more sales personnel are trained for delivering effective presentation to the client. Further, the training using the distributed technique makes the sales personnel to understand the one or more contexts in which the client thinks, and present an effective sales pitch effectively.

The one or more demonstrations to be presented by the one or more sales personnel are generated (Step 104). The demonstrations are presented using the presentation module. According to one embodiment herein, the presentations are generated on a computed device. Examples of the computing device include but are not limited to computers, mobile phones, wearable devices, smart-phones, personal digital assistants, and the like.

According to one embodiment herein, the one or more demonstration to be presented by the one or more sales personnel is created by the authorized personnel. Example of the authorized personnel for generating the one or more demonstration includes sales executive, sales trainer, management personnel and the like.

According to one embodiment herein, the one or more demonstrations is generated by the one or more sales personnel itself. According to one embodiment herein, the one or more demonstrations have a pre-determined format. The format for the demonstrations is created by one or more concerned personnel according to the client profile, and the abilities of the sales personnel.

According to one embodiment herein, the one or more demonstrations comprise a generic content, and a specific content. The generic content includes the content that is suitable for a plurality of the clients, and specific content refers to the content that is relevant to the client.

According to one embodiment herein, the generated demonstrations include initial introduction of the company and the sales personnel, initial introduction of the product or the service, detailed explanation of the product or service, interactive sessions, end note, and the like. Further, the generated one or more demonstrations has the application to allow the sales personnel, sales manager, and an executive to make notes for demonstrating the presentation effectively. The generated demonstration has an application to receive the feedback.

According to one embodiment herein, the feedback is provided by the sales personnel, sales manager, and the client. For example, the feedback can be in given in either subjective, or an objective form.

According to one embodiment herein, the demonstrations generated are in one or more types. Examples of the types of the demonstrations created include but are not limited to video, audio, text, image, multimedia, voice, or a combination of all the mentioned above. Further, the generated demonstrations are adaptable to various environments such as web environment, mobile environment, printer-friendly environment, and the like.

The generated one or more demonstrations are posted to a server. (Step 105). The demonstrations are posted using the presentation module to a server.

According to one embodiment herein, the sales personnel presents the one or more demonstrations to the client by connecting to the server.

According to one embodiment herein, the sales personnel can access the posted one or more demonstrations with the login credentials provided to the sales personnel.

According to one embodiment herein, the posted one or more demonstrations are responsive. The one or more demonstrations are suitable to be presentable in various environments such as web based presentation, mobile based presentation, demonstration using a native mobile application, demonstration using a third-party app, and the like.

According to one embodiment herein, the demonstrations are posted using a communication network. Examples of the communication network include but are not limited to internet, intranet, wireless network, telephone network, Bluetooth, Local area network, Wide-area network, and the like.

According to one embodiment herein, the posted demonstrations are secured and encrypted to prevent activities such as hacking, and damaging the posted one or more demonstrations. Further, according to one embodiment herein, the generated demonstrations are posted along with the one or more similar demonstrations that have provided positive results. The similar demonstrations are matched using call recording and matching module. These similar demonstrations are posted in such a way that the similar demonstrations do not interfere with the main demonstrations and is accessible to the sales personnel and not to the client.

The posted one or more demonstrations along with the similar demonstrations are verified for similar pitches that had favorable outcome in real time (Step 106). According to one embodiment herein, the verification of the similar demonstrations are done using the matching module in the call recording and matching module. According to one embodiment herein, the pitches are considered to have favorable outcomes based on one or more parameters set by rule engine. For example, the pitches are considered as favorable if the customer buys the product after presenting the sales pitch.

The posted one or more presentations are presented to the client by the one or more sales personnel (Step 107). The demonstration of the one or more presentations is on a computing device.

According to one embodiment herein, examples of the computing devices include a computer, laptops, mobile phone, smart phone, personal digital assistants, projectors, and the like. The one or more demonstrations posted on the server are accessed by the sales personnel using an access terminal.

According to one embodiment herein, the sales personnel is provided access to the posted one or more demonstrations using the login credentials provided to the sales personnel.

According to one embodiment herein, the one or more demonstrations are presented on one or more computing devices simultaneously. Further, selected contents of the one or more demonstrations Further, the demonstrated one or more presentations to the client are real-time, geo-stamped, and time-stamped.

According to one embodiment herein, the one or more presentations as demonstrated by the sales personnel are recorded for quality check, and analyzing the demonstration. Furthermore, the demonstrations of the one or more sales pitch are geo-stamped for tracking the sales personnel's location. Furthermore, the demonstrations of the one or more sales pitch are time-stamped for tracking the demonstration time of the sales personnel. Further, the time-stamping is done for analyzing the interest shown by the client on the demonstration and improvising the demonstrations based on the analyzed result.

Once the presentation of the sales personnel is completed, the one or more presentations have the option to receive a feedback. According to one embodiment herein, the feedback is provided by the client on the demonstration, performance of the sales personnel and the like.

According to one embodiment herein, the sales personnel provide the feedback on the client reaction, minutes of meeting, convertibility and the like.

According to one embodiment herein, the sales manager provides the feedback on the performance of the sales personnel, tags for the one or more demonstration, next course of action, and the like.

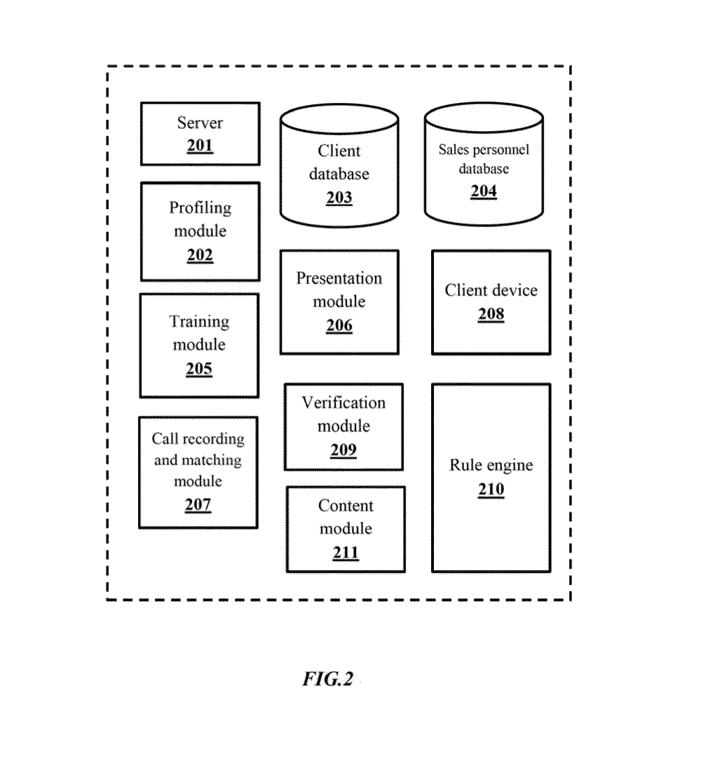

FIG. 2 illustrates the system components for presenting the sales pitch, according to one embodiment herein. The system components includes a server 201, a profiling module 202, a client database 203, a sales personnel database 204, a training module 205, a presentation module 206, a call-recording and matching module 207, a client device 208, a verification module 209, a content module 211 and a rule engine 210.

FIG. 2 includes the server 201. According to one embodiment herein, the server 201 is a computing device for accepting requests from one or more applications and giving responses accordingly. For example, the server 210. According to one embodiment herein, the one or more presentations prepared for one or more clients are posted on the server 201. The one or more sales personnel access the one or more presentations using the server 201. Further, the server is linked to one or more databases for obtaining plurality of the information such as client information, sales personnel information, statistics, and the like.

FIG. 2 includes a profiling module 202. The profiling module 202 is used for profiling the plurality of the clients using one or more parameters. The one or more parameters for profiling the client include but are not limited to information provided by the client, summary of the client, resources provided by the client, resources allocated for the client, past transactions with the client, and the like.

According to one embodiment herein, the profiling of the one or more client is performed manually by the one or more sales personnel. According to one embodiment herein, a processor fed with the above mentioned parameters perform the profiling of the one or more clients.

FIG. 2 includes the client database 203. The client database 203 stores the plurality of the information about the one or more clients. The information stored in the client database 203 include but are not limited to client profile, name of the concerned authorities, financials of the client, resources allocated for the client, one or more sales personnel assigned for the client, rating of the client and the like. The client database 203 is accessible to the sales executives, and sales managers through the server 201.

FIG. 2 includes the sales personnel database 204. The sales personnel database 204 is used for storing a plurality of the sales personnel information. The information stored in the sales personnel database 203 include but are not limited to sales personnel full name and address, qualification of the sales personnel, designation of the sales personnel, scores obtained by the sales personnel in the plurality of the quizzes, rating of the client, and the like. The sales personnel database 204 is accessible to the sales managers and higher executives through the server 201.

FIG. 2 includes a content module 211. The content module 211 is used for storing the plurality of the content related to the product offerings, service offerings, sales and marketing asset and the like. According to one embodiment herein, the plurality of the content in the content module 211 is arranged according to the one or more categories pre-defined by the rule engine 210.

FIG. 2 includes a training module 205. The training module 205 is used for providing training for the plurality of sales personnel. The training module comprises the contents to be taught to the sales personnel for presenting an effective sales pitch. The training module contains both online material and offline material, and the respective methods for evaluating the plurality of the sales personnel. Further the training module 205 comprises information about the methods in which the training has to be provided for the plurality of the sales personnel. According to one embodiment herein, the training module 205 is updated periodically for providing better training for the plurality of the sales personnel. According to one embodiment herein, the training module provides training to the plurality of the sales personnel using distributed learning technique.

FIG. 2 includes the presentation module 206. According to one embodiment herein, the presentation module 206 is used for generating one or more presentations and posting the generated one or more presentations to the server 201. According to one embodiment herein, the presentation module 206 has one or more tools for generating the one or more presentations for the plurality of the clients. For example, the presentation module 206 generates the presentation in textual format, audio format, image format, multi-media format, power point format, or a combination of these. According to one embodiment herein, the presentation module 206 generates the one or more presentations with the help of a manual effort. According to one embodiment herein, the presentation module 206 generates the one or more presentations and posts it on the server 201 automatically. Further, according to one embodiment herein, the presentation module 206 also provides one or more tools for posting the one or more presentations to the server 201.

FIG. 2 includes a call recording and matching module 207. According to one embodiment herein, the call recording and matching module 207 is used for recording the presentation of the sales pitch presented by the plurality of the sales personnel. According to one embodiment herein, the recording of the presentations include call recording, video recording, and the like.

Further, the call recording and matching module 207 matches the plurality of the presentations presented by the plurality of the sales personnel using one or more matching algorithms. According to one embodiment herein, the call recording is done for assessing the sales personnel and providing it as a training material to other sales personnel.

FIG. 2 includes the client device 208. According to one embodiment herein, the client device 208 refers to any device on which the one or more presentations are demonstrated to the one or more clients. According to one embodiment herein, the client device 208 is a computing device. The examples of the client device 208 include but are not limited to a computer, a laptop, a personal digital assistant (PDA), a smart phone, a projector, a gaming console, a wearable device and the like. According to one embodiment herein, the client device 208 has the capability to provide the geo-location when the presentation is demonstrated.

FIG. 2 includes the verification module 209. According to one embodiment herein, the verification module 209 verifies the geo-location of the client device 208, when the one or more presentations are demonstrated to the client. According to one embodiment herein, the verification module 209 verifies the location of the client device 208 by receiving the geo co-ordinates of the client device 208.

FIG. 2 includes a content module 211. According to one embodiment herein, the content module 211 stores a plurality of information about the product offerings, service offerings, sales and marketing asset. According to one embodiment herein, the product offerings, service offerings, marketing and sales assets are categorized based on the one or more parameters. According to one embodiment herein, the one or more parameters are set by the rule engine.

According to one embodiment herein, the content module 211 include information regarding the products, services on which the sales pitch has to be generated. According to one embodiment herein, the information regarding the products and services include generic product or service content, and specific product or service content.

According to one embodiment herein, the product or service content is modified and updated by the concerned personnel such as sales personnel.

According to one embodiment herein, the plurality of the sales personnel fetch the data from the client database 203, and the content module 211 to generate effective one or more presentations for demonstrating the sales pitch.

FIG. 2 includes the rule engine 210. According to one embodiment herein, the rule engine 210 sets one or more rules for plurality of the system components for effective working of the system. According to one embodiment herein, the rule engine 210 is configured to set one or more parameters for the profiling module 202, the training module 205, and the presentation module 206, the call recording and matching module 207, the verification module 209.

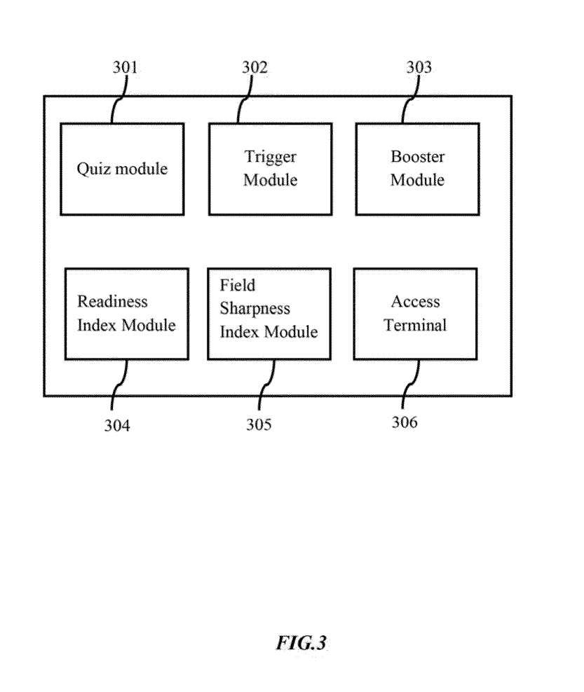

FIG. 3 illustrates a block diagram of a distributed learning system for training the sales personnel, according one embodiment of herein. With respect to FIG. 3, the system comprises a quiz module 301, triggering module 302, a booster module 303, a readiness index (RI) module 304, a field sharpness index (FSI) module 305 and an access terminal 306. The trainings are conducted before and across the duration of the sales campaign.

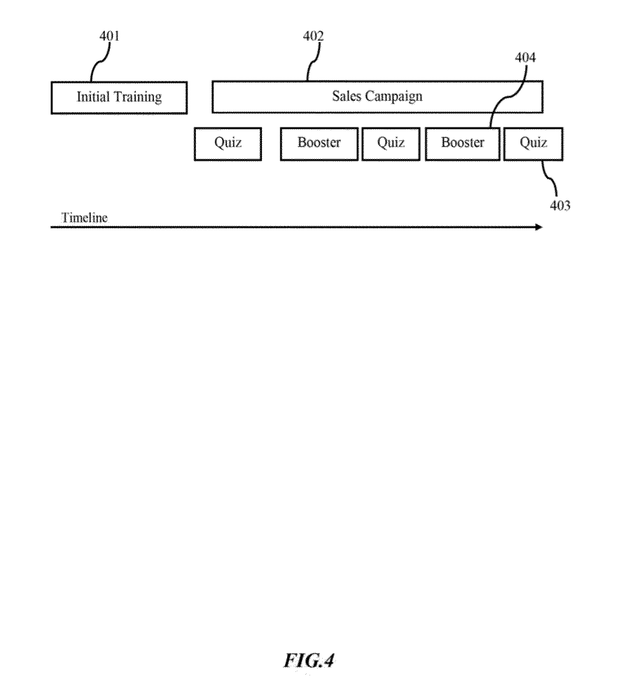

FIG. 4 is a block diagram illustrating a timeline representation of the initial training and campaign, according one embodiment herein. With respect to FIG. 4, the training session is started with an initial training program 401. The initial training program 401 is to familiarize the sales personnel with product knowledge, sales techniques, name gathering and the like. A quiz 403 is conducted after the completion of initial training, to measure performance of the sales person in the initial training. The initial training is followed by commencement of sales campaign 402. The system conducts several quizzes 403 to measure the performance of the sales personnel during the sales campaign. In addition to the initial training, there are several “booster” sessions 404 that are tailored to provide required missing/additional training based on the feedback results.

According to one embodiment herein, the system comprises a quiz module that creates a set of question banks, wherein each question is associated with multiple-choice answers (with the correct answer marked). A set of questions from the question bank is grouped to form a quiz. The quiz is also associated with a training category and specific trainings within a category. The quizzes are conducted and administered asynchronously over a period of time. The quizzes are administrated over a range of mechanisms such as but not limited to SMS, websites, mobile application and interactive voice response (IVR) based system. Each quiz measures dimension of two parameters associated with the performance of sales personnel with reference to the training. The first parameter dimension measures campaign knowledge of the sales person. The campaign knowledge of the sales person is measured depending on the number of correct responses answered to the quiz. The second parameter measures responsiveness of the sales person. The responsiveness is measured based on how quickly the sales person responds to the quiz questions. For example the responsiveness parameter is measured based on whether the sales person respond to the quiz in the same day or he/she waits until a reminder is sent. There are also several other dimensions that measure responsiveness of the sales person. The system generates real time feedback for each sales person depending on their response to quizzes and their engagement level in training and sales campaign sessions.

According to one embodiment herein, the system enables learning in real time, which eliminates deficiencies in the retained information by specific sales personnel. The system facilitates change of course and mid-way correction of the sales campaign. The system comprises configurable triggers to initiate corrective actions.

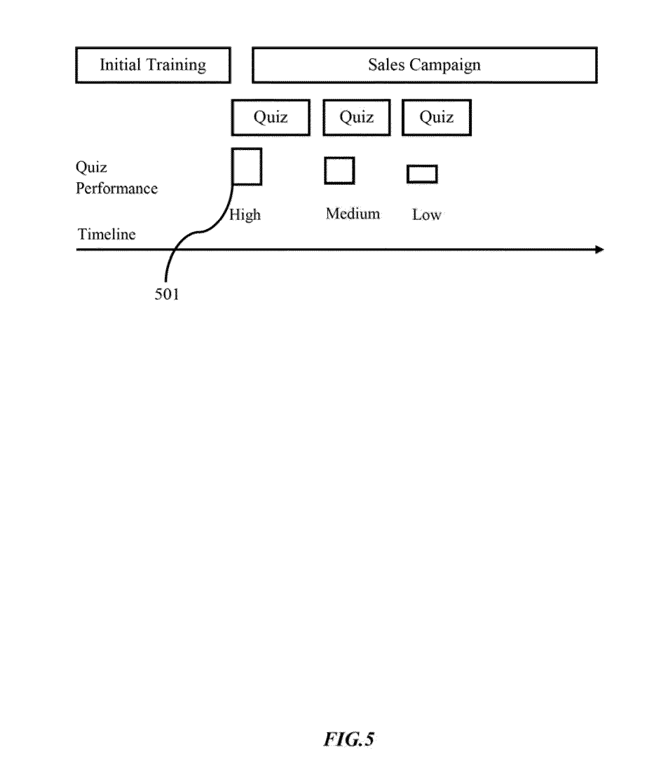

FIG. 5 is a block diagram illustrating a timeline representation for generating triggers to initiate corrective actions, according to one embodiment herein. With respect to FIG. 5, the triggers are generated depending on the performance 501 of the sales person relating with respect to several quizzes. The quiz performance of a sales person is represented in terms of high, medium, or low performance levels. The system further comprises a triggering module for generating a trigger, whenever the sales person shows low quiz performance 501.

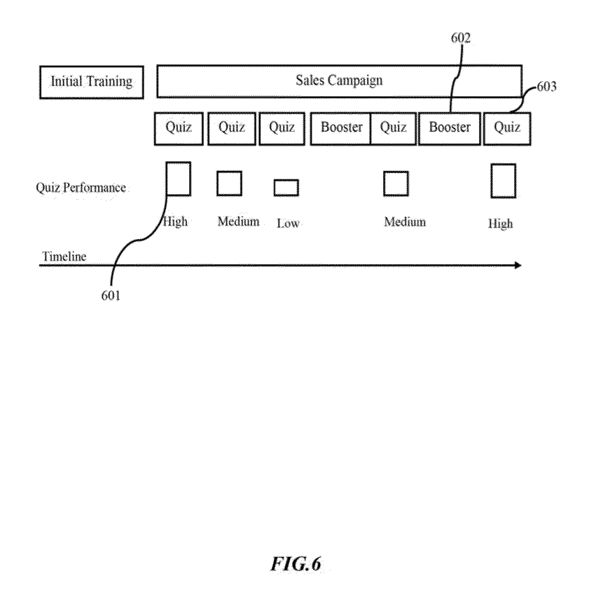

FIG. 6 is a block diagram illustrating a timeline representation for booster trainings conducted during the sales campaign, according one embodiment herein. Based on the triggers 601, the tailored booster trainings 602 are conducted. The system comprises a booster module for administering conduction of booster trainings. The booster module further monitors the impact of the booster trainings 602 by conducting subsequent quizzes 403 until the expected performance levels are met.

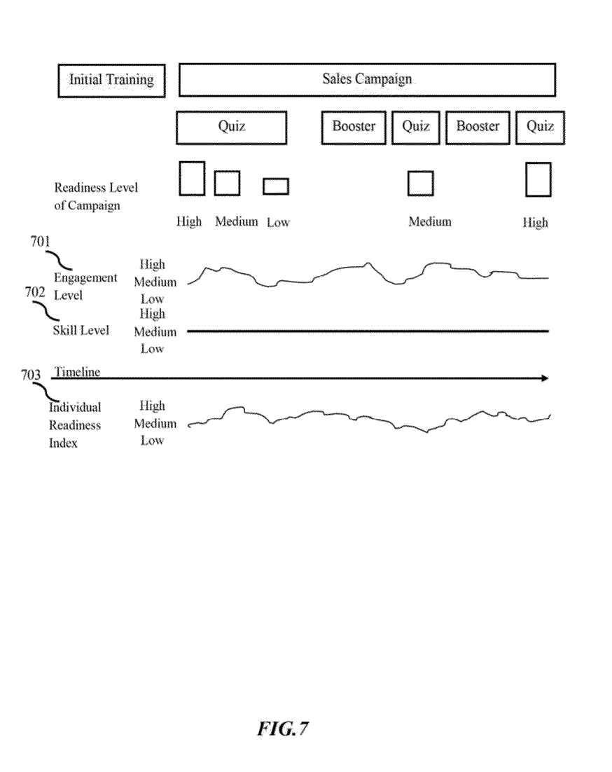

FIG. 7 is a block diagram illustrating a timeline representation for Readiness Index (RI) of an individual sales person, according to one embodiment herein. With respect to FIG. 7, the system generates a Readiness Index (RI) 703 for representing the extent of the readiness of a given sales personnel with respect to a defined objective. The readiness index (RI) module of the system calculates RI 703 for each sales person considering at-least three constituents, such as Product and Campaign Readiness, Engagement Level 701, and Skill Readiness 702. The Product and Campaign readiness is measured based on the correct response to the quiz answered by the sales person. The points are assigned based on the responses to the quiz and these points are aggregated over a campaign to represent campaign readiness. The Engagement Level of the sales person is measured based on various dimensions, including but not limited to consistency, agility in response, and the scoring in periodic cognitive quizzes. The points assigned to a quiz comprise a ‘bonus’ feature which get awarded to the fastest responses. The engagement level of the sales person is represented in terms of different measurement levels (for example bronze, silver, and gold/red, yellow and green) depending on his performance during the campaign. The skill readiness 702 is measured based on the education, experience and scores of the quizzes related to a specific skill based trainings. The above four constituents are aggregated over the period of the campaign for each sales personnel, giving an individual's Readiness Index (RI) 703.

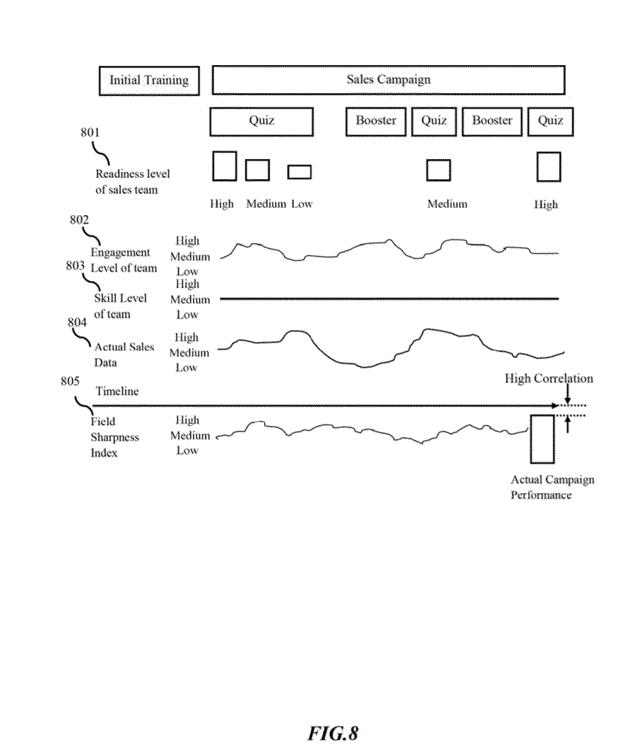

FIG. 8 is a block diagram illustrating a timeline representation for Field Sharpness Index (FSI) of a sales team, according to one embodiment herein. With respect to FIG. 8, the system calculates Field Sharpness Index (FSI) 805, and represents the extent of readiness of the plurality of the sales personnel with respect to a defined objective. Each sales personnel has a range of readiness levels at a given point of time, corresponding to a range of Product lines and campaigns. The individual RIs of the plurality of sales personnel are aggregated based on (but not limited to) product lines, geography, markets, and retail chains. The derived RI aggregate 801 represents FSI 805 of the plurality of sales personnel. The data is aggregated at a daily/weekly/monthly basis. The FSI is calculated by convolving individual readiness indices of the constituent sales team members 801. The FSI module further calculates FSI 805 by aggregating sub-indices, for example, by aggregating Product and Campaign readiness and/or aggregating Engagement Levels 802 and/or aggregating team skill levels 803 and/or aggregating actual sales data 804. The actual sales data 804 is received at the product level. The actual sales data 804 provides sales details of the sales person such as the person's name, department, zone, target product name, product sales. The FSI module assigns different weights to the FSI sub components viz. product readiness, engagement level 802, skill level 803 and actual sales data 804. The FSI module further provides aggregation of FSI 805 based on a selected range of products and/or on a selected range of campaigns and/or over a selected range of geographies. The system keeps a track on the individual RI indexes and the aggregate FSI indexes 805 over the period of defined campaigns. This information is utilized for putting together teams for specific assignments.

According to one embodiment herein, the users (sales persons) are provided with an access to the system through an access terminal, which could be a laptop computer, a desktop computer, a Personal Digital Assistants (PDA), a mobiles phone, a smart phone, and computing device. The users include sales personnel, a sales/product managers or administrators. The access terminal displays all the information related to sales personnel, conducted quizzes, trainings, campaigns, product and product lines. The access terminal further provides a user interface, through which the user is also allowed to configure the content displayed on the access terminal. The user accesses the system via a web based login. There are separate login modes available for different users. The login screen is customizable according to user preference.

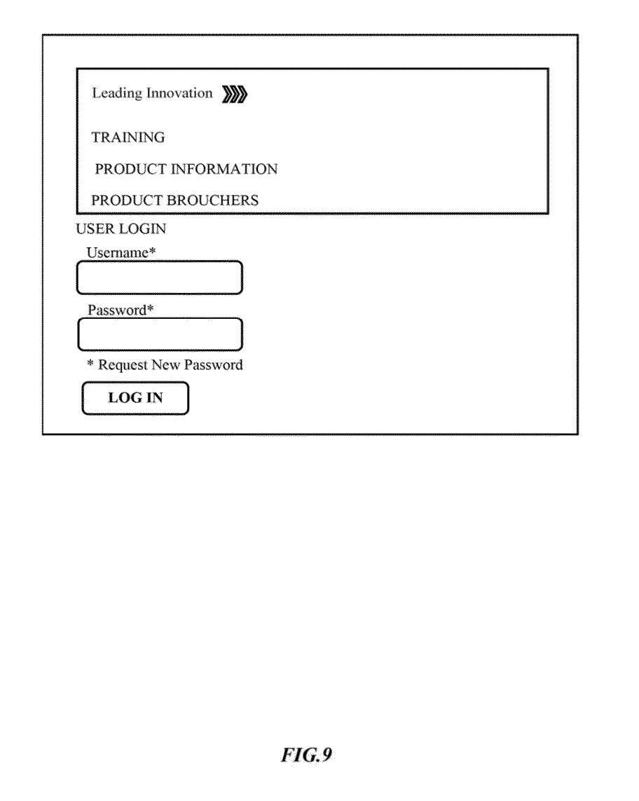

FIG. 9 is a screenshot illustrating a configurable login screen for the user to access the system, according to one embodiment herein. The system of the embodiments herein provides a provision for user to configure product categories (e.g. Laptops), product lines (e.g. Osmium) and products/SKU's (Model W500). The user utilizes access terminal to configure the product categories, product lines and products/SKUs. The trainings are provided depending on the product categories, product lines and products/SKU's assigned to the sales personnel. Once the product categories and products are configured, the product details appear on a learning screen of the assigned sales personnel.

According to one embodiment herein, the system further provides a provision for the user to configure campaigns related to specific product categories, product lines and products/SKU. In addition to the product information, a campaign comprises parameters such as but not limited to: sales team associated with the campaign; the start and end time of the campaign and the trainings conducted during the campaigns. The user utilizes access terminal to configure various parameters relating to the campaign.

According to one embodiment herein, the system further provides a provision for the user to configure training content. There can be several categories of the training content including but not limited to: products and product lines training, mandatory company training, process training and skills training. The training content is presented to the users by using a wide range of mediums such as but not limited to, classroom trainings, web browser based trainings, mobile training applications and the like. All the training content is cataloged in the system. The users can acquire the training content by accessing the system, through access terminal.

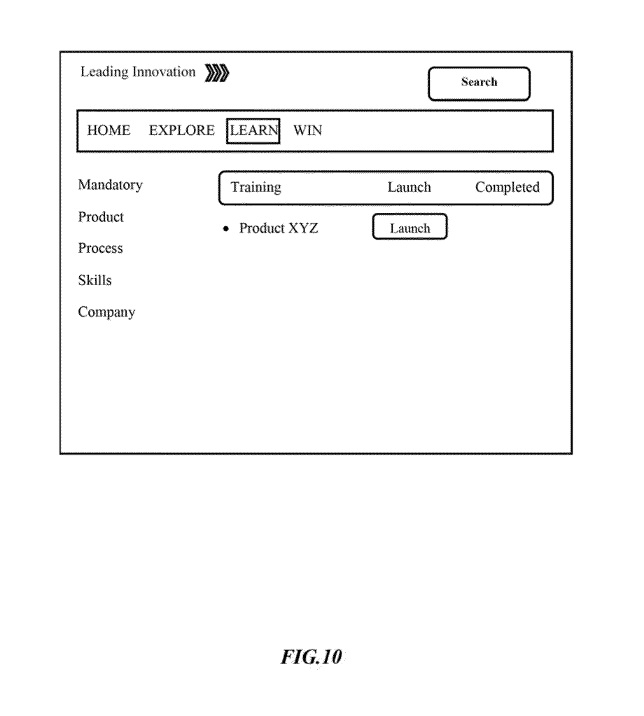

FIG. 10 is a screenshot illustrating a configurable training screen for the user to edit training content, according to one embodiment herein. The system further provides a provision for the user to configure quiz content. The user can edit various parameters relating to the conduction of quiz. The various parameters comprises (but are not limited to): the dispatch mechanism (how the quiz is delivered to the sales person: using SMS, Web page or IVR); timing of dispatch of the quiz, including but not limited to: dispatching at regular timing intervals throughout the campaign, randomly dispatching the quiz within a configured window, manually presetting time of dispatch; number of attempts allowed; importance level, which provides additional weight age mechanism for Readiness Index computations

According to one embodiment herein, the user is able to access and configure information related to the sales personnel using the access terminal. The information is uploaded to the system via bulk upload using administrator configuration screens or individual configuration screens. The sales personnel are further assigned to configurable groups such as markets, geographies or retailers, etc. Each sales person has an individual login ID and login account. The account page of a particular sales person shows their personal Readiness Index with respect to applicable campaigns. The account also summarizes composite FSI for the applicable campaigns in addition to the status of assigned courses and the total amount of points from the completed quizzes. The points and FSI for the sales person is seen in their profile page.

According to one embodiment herein, the access terminal of the system displays an administrator menu that is accessed via the administrator login. The menu provides access to all the configuration screens including but not limited to: sales personnel (RSP) configuring screen, screen displaying quizzes, screen providing training questions for quizzes and screen displaying banner images in the site.

According to one embodiment herein, the system generates reports and provides analytics reflecting the readiness of the sales team across the product lines, campaigns, geographies and markets, including but not limited to: aggregation based on a selected range of products; aggregation based on a selected range of campaigns; and aggregation based on a selected range of geographies; aggregation based on all the sales personnel in a given geography working on a selected range of products and campaigns. The system lists down the individual readiness index of all the sales personnel based on a selected range of products and campaigns. The system allows selection of specific sales personnel and will calculate the projected FSI for a particular group. The system allows aggregation of FSI based on a selected range of markets and retail outlets. In addition to FSI based reports, the system also provides aggregate reports on training sessions, for example, how many training sessions were conducted, how many sales persons have participated in a particular training session etc.

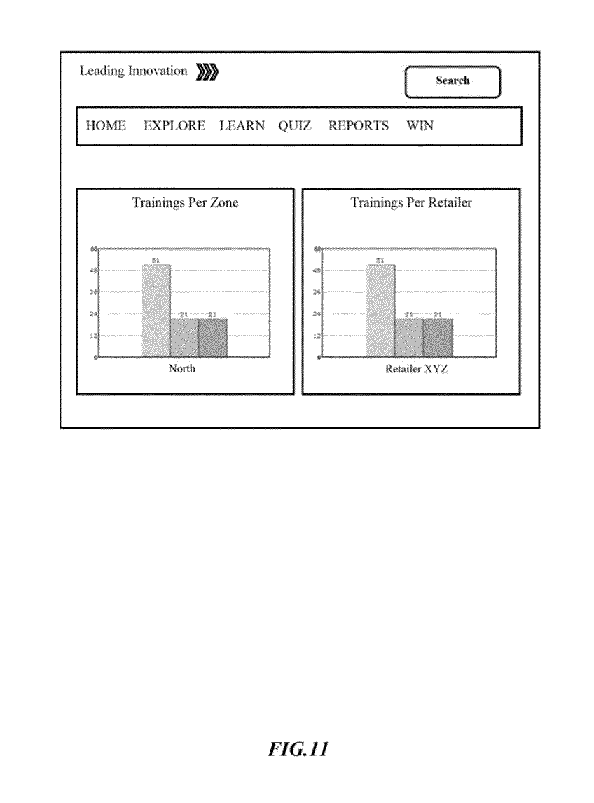

FIG. 11 is a screenshot illustrating a screen for displaying aggregated reports on trainings, according to one embodiment herein. The system of the embodiments herein is also accessible via a mobile application.

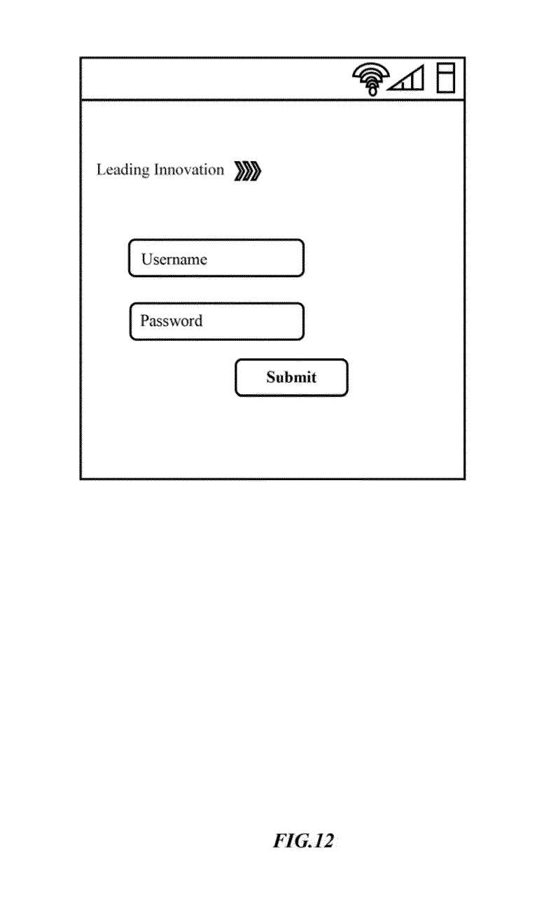

FIG. 12 is a screenshot illustrating a display screen of a mobile application for accessing the system by the user, according to one embodiment herein. With respect to FIG. 12, the mobile application provides both offline and online working modes for the system, wherein the system is accessed via a downloadable native application or an online web application. The mobile application further enables easy access to the features of the system via smart-phones and tablets.

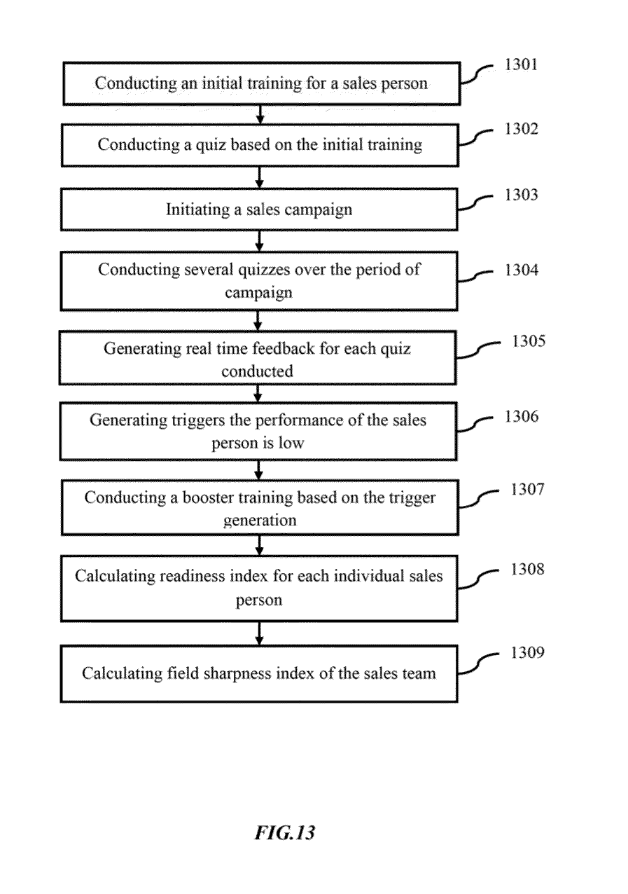

FIG. 13 is a flowchart illustrating a distributed learning method for training the sales personnel, according to one embodiment herein. The method comprises the steps of: conducting of an initial training program for a sales person (Step 1301); conducting a quiz to measure the performance of each individual in the initial training (Step 1302); commencing a sales campaign, after completion of the quiz (Step 1303); conducting several quizzes asynchronously over the period of the campaign (Step 1304); generating a real time feedback depending on the performance of the sales person for each quiz conducted (Step 1305); generating a trigger when the performance of the sales person is low (Step 1306); conducting a booster training based on the trigger generation (Step 1307); calculating readiness index for each individual sales person, depending on their performance during the campaign (Step 1308); and aggregating the readiness indices of all the sales people in a sales team, to calculate field fitness index of the sales team (Step 1309).

According to one embodiment herein, the mobile application is preloaded with one or more product or service campaigns for offline accessing. Each mobile application installed in the mobile computing devices such as but not limited to mobile phones, PDA's, smart-phones, tablets, etc. is assigned with a unique identification number (ID). The unique ID of the mobile application is stored in the system along with the specific sales personnel or group of sales personnel identification number. Each time a specific sales personnel initiates a campaign, a content archive is created. The content archive comprises one or more multimedia content such as but not limited to product videos, demos, product brochures, specification sheets, case studies, publications etc. The content archive is created based on one or more questions asked to the customer. The content archive is adapted based on one or more answers. The system further records the actual usage of the content from the content archive during the sales pitch. The subset of the content (from the content archive) along with the time stamp and the mobile application's unique ID is stored in the system for validating the actual sales pitch made by the sales personnel.

According to one embodiment herein, the system records a geo stamp to tie the sales pitch to a unique customer. Further, the system prompts the sales person to select a specific customer if there is more than one customer assigned to a location.

According to one embodiment herein, the mobile application accesses the system to buffer and play one or more product or service campaigns in real time during campaigning. Further, a content archive comprising one or more multimedia content such as but not limited to product videos, demos, product brochures, specification sheets, case studies, publications etc., is created. The content archive is created based on one or more questions asked to the customer. The content archive is adapted based on one or more answers. The system further records the actual usage of the content from the content archive during the sales pitch. The subset of the content (from the content archive) along with the time stamp and the mobile application's unique ID is stored in the system for validating the actual sales pitch made by the sales personnel.

According to one embodiment herein, the system records a geo stamp to tie the sales pitch to a unique customer. Further, the system prompts the sales person to select a specific customer if there is more than one customer assigned to a location.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A method for presenting a sales pitch or forum using a computing device, the method comprising steps of:
receiving information about a client from a plurality of sources;
creating a client profile using a profiling module, wherein creating a client profile includes receiving information about the client, and wherein the client profile is created based on one or more parameters;
creating a product and service profile using the profiling module, wherein creating the product and service profile includes a plurality of details about the product, service, and sales and marketing assets;
training one or more sales personnel using an online and an offline mode based on the client profile using a training module, wherein the online mode training refers to training the sales personnel using web-enabled applications, and the offline training refers to a classroom training of the one or more sales personnel, and wherein training the one or more sales personnel is through a distributed learning technique;
generating one or more demonstrations of a sales pitch using a presentation module, wherein the one or more sales pitch is demonstrated by the sales personnel;
posting the one or more generated demonstrations of the sales pitch to a server using the presentation module; and
presenting the one or more posted presentations of the sales pitch on a computing device by the sales personnel to the client, wherein the computing device includes a computer, smart-phone, personal-digital assistant, projector having one or more applications for giving access to the client for the one or more presentations, and wherein the one or more applications include email, secure companion mobile app, and wherein the presentations are recorded in real-time, geo-stamped, and time-stamped.

2. The method according to claim 1, wherein the step of obtaining the information about the client in a plurality of the sources includes collecting information directly from the client, and acquiring information about the client indirectly from a plurality of other sources.

3. The method according to claim 1, wherein the one or more parameters for creating the client profile is pre-set, wherein the one or more pre-set parameters include information of the client, market position the client, client interest level, resources provided by the client, and summary of the client, and wherein the one or more parameters are pre-set by authorized personnel.

4. The method according to claim 1, wherein the step of training the plurality of sales personnel using the training module through the distributed learning technique comprises:
conducting an initial training for the plurality of the sales personnel, wherein conducting the initial training for the plurality of the sales personnel includes familiarizing the plurality of the sales personnel with product knowledge, one or more sales technique, and name gathering;
conducting a quiz based on the initial training using a quiz module, wherein the quiz is conducted for measuring the performance and understanding levels of the plurality of sales personnel in the initial training;
initiating a sales campaign, wherein the sales campaign is initiated by the sales manager;
conducting a plurality of quizzes using the quiz module over the period of campaign, wherein the plurality of the quizzes are conducted for measuring the performance of the sales personnel;
generating a real-time feedback for each of the plurality of quizzes conducted, wherein the feedback for the plurality of the quizzes are based on one or more parameters, and wherein the one or more parameters for the quizzes are pre-determined;
generating triggers using a trigger module when the performance of the sales personnel is low;
conducting a booster training using a booster module based on the trigger generated;
calculating a readiness index for each of the plurality of the sales personnel using the readiness-index module, wherein the readiness index is calculated for measuring the readiness of the plurality of the sales personnel, and wherein the readiness index is calculated based on one or more parameters; and
calculating a field sharpness index of the sales team comprising the plurality of sales personnel using the field sharpness index module by convolving the individual readiness indices of the constituent sales team personnel.

5. The method according to claim 1, wherein step of generating one or more demonstrations of a sales pitch comprises creating a generic content, creating a specific content, and providing a tool for customizing the generic content, and the specific content, wherein the generic content includes general introduction, and specific content includes information about the product and service to be demonstrated to the client.

6. The method according to claim 1, further comprises encrypting and securing the one or more demonstrations of the sales pitch using one or more secure protocol, wherein the demonstration of the sales pitch include the presentation of the product and service to the client through electronic and non-electronic medium.

7. The method according to claim 1, further comprises call recording and matching using the call recording and matching module, wherein call recording and matching is for providing the sales personnel with the similar sales pitch conducted earlier.

8. The method according to claim 1, further comprises sharing the one or more presentation with the client on a computing device using one or more ways, wherein the one or more ways include sharing using a web application, a mobile application, and a vault application.

9. The method according to claim 1, wherein the one or more posted presentation has one or more field to include feedback from the sales personnel, and the client.

10. A system for presenting a sales pitch, the system comprising:
a server configured for running a plurality of the applications received from plurality of sources;
a client database for storing information about a plurality of the clients;
a sales personnel database for storing information about a plurality of the sales personnel;
a content module for storing a plurality of the information about the product and service offerings;
a training module configured for providing a customized training according to the requirement of the client;
a presentation module configured for creating and posting one or more sales pitch demonstration on a web server;
a client device for demonstrating the one or more sales pitch; and
a verification module configured for verifying activities of the pluralities of the sales personnel.

11. The system according to claim 10, wherein the training module comprises:
a quiz module configured for providing a plurality of quizzes for the plurality of the sales personnel and receiving answers from the plurality of the sales personnel;
a trigger module configured for triggering an authorized personnel when performance is low, wherein the performance refers to the ability of the individual ales personnel to answer to the plurality of quizzes with respect to a defined objective;
a booster module configured for providing booster training for one or more sales personnel;
a readiness-index module configured for calculating a readiness-index of each of the plurality of the sales personnel, wherein the readiness-index refers to the extent of the readiness of the individual sales personnel with respect to a defined objective;
field sharpness index module for calculating a field sharpness of the each of the plurality of the sales personnel, wherein the field sharpness index refers to the extent of readiness of the plurality of the sales personnel with respect to a defined objective; and
access terminal for accessing a plurality of the contents, wherein the access terminal is present on the computing device used for accessing the posted presentation, and wherein the plurality of the contents include login and registration details of the sales personnel, plurality of scores from quizzes, one or more contents to be demonstrated, and a feedback.

12. The system according to claim 10 further comprises a recording and matching module configured for recording a demonstration of the plurality of the presentations and matching the one or more demonstrations in the past based on one or more parameters, wherein the one or more parameters include similar presentations, similar clients, presentations referring to similar target audience.

13. The system according to claim 12, wherein the call recording and matching module comprises a call pattern matching module for matching the one or more similar presentations contextually.

14. The system according to claim 10 further comprises a rule engine for setting one or more parameters for a plurality of modules for presenting the sales pitch.

15. A computer implemented method for presenting a sales pitch or forum using computing device, the method comprising instructions stored on a non-transitory computer readable storage medium and executed on one or more processors to perform the steps of:
receiving information about a client from a plurality of sources;
creating a client profile using a profiling module, wherein creating a client profile includes receiving information about the client, and wherein the client profile is created based on one or more parameters;
creating a product and service profile using the profiling module, wherein creating the product and service profile includes a plurality of details about the product, service, and sales and marketing assets;
training one or more sales personnel using an online and an offline mode based on the client profile using a training module, wherein the online mode training refers to training the sales personnel using web-enabled applications, and the offline training refers to a classroom training of the one or more sales personnel, and wherein training the one or more sales personnel is through a distributed learning technique;
generating one or more demonstrations of a sales pitch using a presentation module, wherein the one or more sales pitch is demonstrated by the sales personnel;
posting the one or more generated demonstrations of the sales pitch to a server using the presentation module;
presenting the one or more posted presentations of the sales pitch on a computing device by the sales personnel to the client, wherein the computing device includes a computer, smart-phone, personal-digital assistant, projector having one or more applications for giving access to the client for the one or more presentations, and wherein the one or more applications include email, secure companion mobile app, and wherein the presentations are recorded in real-time, geo-stamped, and time-stamped;
encrypting and securing the one or more demonstrations of the sales pitch using one or more secure protocol, wherein the demonstration of the sales pitch include the presentation of the product and service to the client through electronic and non-electronic medium;
performing a call recording and matching processes using the call recording and matching module, wherein call recording and matching is for providing the sales personnel with the similar sales pitch conducted earlier; and
sharing the one or more presentation with the client on a computing device using one or more ways, wherein the one or more ways include sharing using a web application, a mobile application, and a vault application.

16. The computer implemented method according to claim 15, wherein the step of obtaining the information about the client in a plurality of the sources includes collecting information directly from the client, and acquiring information about the client indirectly from a plurality of other sources.

17. The computer implemented method according to claim 15, wherein the one or more parameters for creating the client profile is pre-set, wherein the one or more pre-set parameters include information of the client, market position the client, client interest level, resources provided by the client, and summary of the client, and wherein the one or more parameters are pre-set by authorized personnel.

18. The computer implemented method according to claim 15, wherein the step of training the plurality of sales personnel using the training module through the distributed learning technique comprises:
conducting an initial training for the plurality of the sales personnel, wherein conducting the initial training for the plurality of the sales personnel includes familiarizing the plurality of the sales personnel with product knowledge, one or more sales technique, and name gathering;
conducting a quiz based on the initial training using a quiz module, wherein the quiz is conducted for measuring the performance and understanding levels of the plurality of sales personnel in the initial training;
initiating a sales campaign, wherein the sales campaign is initiated by the sales manager;
conducting a plurality of quizzes using the quiz module over the period of campaign, wherein the plurality of the quizzes are conducted for measuring the performance of the sales personnel;
generating a real-time feedback for each of the plurality of quizzes conducted, wherein the feedback for the plurality of the quizzes are based on one or more parameters, and wherein the one or more parameters for the quizzes are pre-determined;
generating triggers using a trigger module when the performance of the sales personnel is low;
conducting a booster training using a booster module based on the trigger generated;
calculating a readiness index for each of the plurality of the sales personnel using the readiness-index module, wherein the readiness index is calculated for measuring the readiness of the plurality of the sales personnel, and wherein the readiness index is calculated based on one or more parameters;
calculating a field sharpness index of the sales team comprising the plurality of sales personnel using the field sharpness index module by convolving the individual readiness indices of the constituent sales team personnel.

19. The computer implemented method according to claim 15, wherein step of generating one or more demonstrations of a sales pitch comprises creating a generic content, creating a specific content, and providing a tool for customizing the generic content, and the specific content, wherein the generic content includes general introduction, and specific content includes information about the product and service to be demonstrated to the client.

20. The computer method according to claim 15, further comprises providing one or more posted presentations with one or more fields to include a feedback from the sales personnel and the client.
